(19) United States
(12) Patent Application Publication
(10) Pub. No.: US 2004/0196364 A1
(43) Pub. Date: Oct. 7, 2004

(54) Electronic endoscope system

(75) Inventor: Akihiro Takahashi, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/814,227

(22) Filed: Apr. 1, 2004

(30) Foreign Application Priority Data
Apr. 4, 2003 (JP) 2003-101705

(51) Int. Cl. H04N 7/18

(52) U.S. Cl. 348/65

(57) ABSTRACT

An electronic endoscope system has an electronic endoscope and a processor that processes an output of the electronic endoscope. The electronic endoscope includes an image capturing element adapted to capture an image of an object to be observed, a signal processing circuit that receives the output of the image capturing element and generates a digital video signal, a digitized information outputting system that outputs digitized information representing at least information intrinsic to the electronic endoscope and control information for the processor, and a digitized information superimposing system that superimposing the digitized information output by the digitized information outputting system on the digital video signal output by the signal processing circuit.

### BACKGROUND OF THE INVENTION

The present invention relates to an electronic endoscope system having an electronic endoscope that outputs a digital video signal and a video processor that processes the video signal output by the electronic endoscope.

The electronic endoscope generally outputs a digital video signal representing an image captured by a built-in image capturing device such as a CCD (Charge Coupled Device). The output digital video signal is transferred to the video processor which processes the digital video signal and generates an analog video signal, such as the NTSC signal. The analog video signal is transmitted to a displaying device. An operator of the electronic endoscope system can observe the image captured by the image capturing device on the displaying device.

An example of such an electronic endoscope system is disclosed in Japanese Patent Provisional Publication HEI 5-316513. According to the electronic endoscope system disclosed in the publication, the digital video signal output by the image capturing device is compressed in accordance with a time-division multiplex (TDM) method, therefore the number of cables for transferring the video signal from the electronic endoscope to the video processor is reduced in comparison with a conventional endoscope system which does not employ the TDM method.

According to the electronic endoscope system shown in the publication, since two color difference signals (R-Y and B-Y) are multiplexed into one signal, a single cable is used to transmit the R-Y signal and B-Y signals. The other signals, however, are not multiplexed, therefore, another cable for transferring the brightness signal of the digital image signal and cables for transmitting control signals, which are generated when operational buttons of the endoscope are operated, should be used.

In general, a cable for transmitting a digital video signal is located close to a cable for transmitting a control signal, and a noise may easily be added in the digital video signal. Therefore, the endoscope system having the configuration as disclosed in the above-identified publication needs a measure for eliminating such a noise.

### SUMMARY OF THE INVENTION

The present invention is advantageous in that the occurrence of the noise in the digital video signal can be reduced effectively.

According to an aspect of the invention, there is provided an electronic endoscope system, which has an electronic endoscope and a processor that processes an output of the electronic endoscope. The electronic endoscope includes an image capturing element adapted to capture an image of an object to be observed, a signal processing circuit that receives the output of the image capturing element and generates a digital video signal, a digitized information outputting system that outputs digitized information representing at least information intrinsic to the electronic endoscope and control information for the processor, and a digitized information superimposing system that superimposes the digitized information output by the digitized information outputting system on the digital video signal output by the signal processing circuit.

Optionally, the electronic endoscope may be provided with a storage, which stores the information intrinsic to the electronic endoscope, the digitized information outputting system retrieving the information intrinsic to the electronic endoscope from the storage.

Further optionally, the information intrinsic to the electronic endoscope may include a type of the electronic endoscope.

In this case, the processor may be configured such that the electronic endoscope outputs the digital video signal including the superimposed digitized information to the processor, and the processor processes the digital video signal extracted from the output of the electronic endoscope in accordance with the information intrinsic to the electronic endoscope.

Still optionally, the electronic endoscope may be provided with at least one operable member which can be operated by a user. The digitized information outputting system may be configured to output the control information in response to an operation of the at least one operable member.

In this case, the processor may include an extracting system that extracts the digitized information from the digital video signal including the superimposed digitized information.

Further, the processor may include a controller that controls a device to which the digitized information as extracted is directed.

In an embodiment, the processor is connected with a displaying device, the controller controlling the displaying device in accordance with the control information represented by the digitized information.

Additionally or alternatively, the processor may be connected with a printing device, the controller controlling the printing device in accordance with the control information represented by the digitized information.

In a particular case, the digital video signal output by the signal processing system may include luminance signal and color difference signals which are multiplexed in accordance with a time-division multiplexing method.

In this case, the digitized information superimposing system may superimpose the digitized information such that the luminance signal, color difference signals and the digitized information are multiplexed in accordance with a time-division multiplexing method.

Optionally, the multiplexed luminance signal color difference signals and the digitized information is a parallel digital video signal, and the electronic endoscope may further include a converting system that converts the parallel digital video signal into a serial digital video signal.

According to another aspect of the invention, there is provided a method of controlling a processor of an electronic endoscope system that includes an electronic endoscope and the processor. According to the method, the electronic endoscope generates a digital video signal. Then, the electronic endoscope superimposes control information for controlling the processor on the digital video signal. The electronic endoscope transmits the superimposed digital video signal including the control information superimposed. Then, the processor receives the superimposed digital video signal and extracts the control information. Then, the processor operates in accordance with the control information.

### BRIEF DESCRIPTION OF THE ACCOMPANYING DRAWINGS

FIG. 1 schematically shows a block diagram of an electronic endoscope system according to an embodiment of the invention; and

FIG. 2A shows a format of the multiplexed digital video signal according to the embodiment of the invention; and

FIG. 2B shows a detailed format of an effective line of the multiplexed digital video signal shown in FIG. 2A.

### DETAILED DESCRIPTION OF THE EMBODIMENTS

Hereinafter, referring to the accompanying drawings, an preferred embodiment of the present invention will be described.

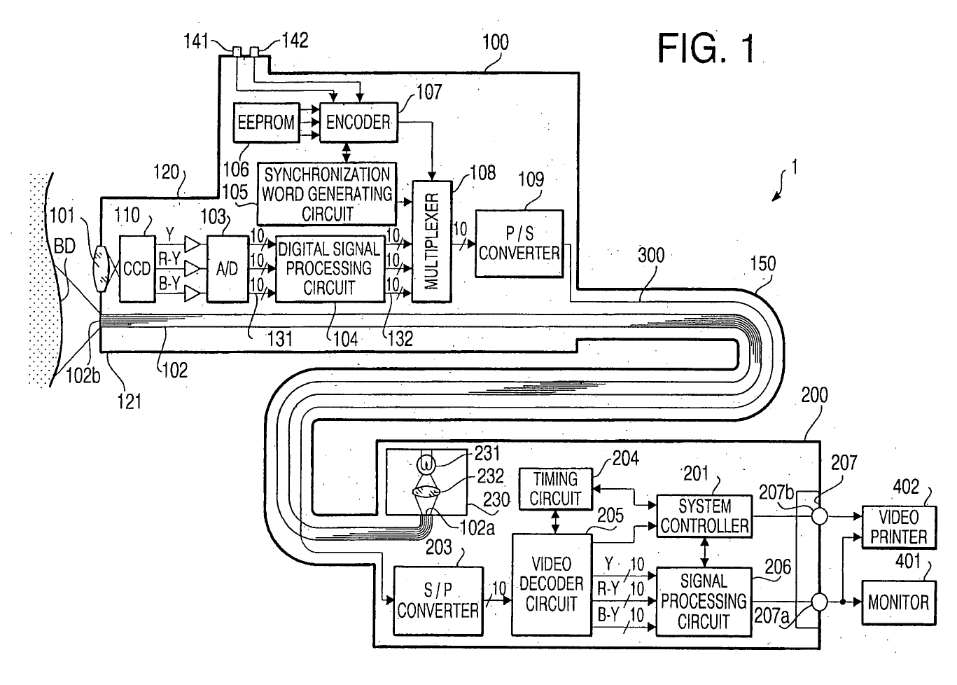

FIG. 1 schematically shows a block diagram of an electronic endoscope system 1 according to an embodiment of the invention. The electronic endoscope system 1 includes an electronic endoscope 100 and a processor 200.

The electronic endoscope 100 includes an objective optical system 101, a light guide 102, a CCD unit 110, an A/D (analog-to-digital) converter 103, a digital signal processing circuit 104, a synchronization word generating circuit 105, an EEPROM (Electronically Erasable Programmable Read Only Memory) 106, an encoder 107, a multiplexer 108, a parallel/serial converter 109, a freeze button 141 and a copy button 142.

The processor 200 includes a system controller 201, a light source unit 230, a serial/parallel converter 203, a timing circuit 204, a video decoder circuit 205, a signal processing circuit 206 and a connector module 207.

The connector module 207 is provided with a video output terminal 207a and a printer control signal output terminal 207b. A monitor 401 is provided and is connected with the video output terminal 207a, and an endoscopic observation image is displayed on the monitor 401. Further, a video printer 402 is provided and is connected with the video output terminal 207a and the printer control signal output terminal 207b. The printer is capable of printing a still image of the endoscopic observation image on a recording medium (a printing paper).

The light source unit 230 outputs illumination light for illuminating in vivo tissues which is an object to be observed with the electronic endoscope 100. The light source unit 230 includes a lamp 231 and a conversion lens 232. The lamp 231 is a white light source such as a Xenon lamp. The conversion lens 232 converges the light emitted by the lamp 231 on a side surface 102a of the light guide 102.

The light incident on the side surface 102a of the light guide 102 proceeds inside the light guide 102, and emerges from the other end (distal end surface 102b) to illuminate the object. The distal end surface 102b is arranged at a tip 121 of an insertion tube 120 of the electronic endoscope 100. With this configuration, the light emitted by the lamp 231 is incident on the object (e.g., in vivo tissues) BD which is located in the vicinity of the tip 121 of the electronic endoscope 100.

An image of the object BD as illuminated is captured using the objective optical system 101 and the CCD unit 110 embedded in the distal end of the insertion tube 120. The objective optical system 101 forms an image of a tissue of the body cavity on a imaging surface of the CCD unit 110. The CCD unit 110 has a built-in color CCD, and outputs YCrCb type analog video signals, which are respectively transmitted to the A/D converters 103.

The A/D converter 103 quantizes the YCrCb type analog video signals to create YCrCb digital signals. A ratio of the sampling frequencies of the digital signal is 4:2:2. Specifically, the luminance information represented by Y-component is given for each pixel of the image, while each of the color difference information represented by Cr and Cb components is shared by two pixels adjoining in the horizontal direction. Further, according to the embodiment, each of the Y, Cr and Cb components is digitized in 10 bits (i.e., each component has range of 0 through 1023 in decimal number format). In other wards, each component of the YCrCb digital video signal has a ten-bit depth. The YCrCb digital video signals are transmitted to the digital signal processing circuit 104 via a 30-bit bus (printed wire pattern) 131.

The digital signal processing circuit 104 performs image processing such as gamma correction and/or other imaging processing with respect to the YCrCb digital video signals. The processed YCrCb digital video signals are then transferred to the multiplexer 108 via another 30-bit bus (printed wire pattern) 132.

The multiplexer 108 applies the TDM to the luminance component Y and the color difference components Cr and Cb. To the multiplexed signal, synchronization words; which are generated by the synchronization word generating circuit 105, and blanking intervals are added, thereby generating multiplexed digital video signal.

An EEPROM 106 stores endoscope information intrinsic to the electronic endoscope 100. The processor 200 executes various operation in accordance with the endoscope information of the electronic endoscope 100 which is currently connected to the processor 200. For example, the system controller 201 determines a photosensitive characteristic of the CCD unit 110 based on the contents of the endoscope information, and processes the video signal so that the image is displayed on the monitor 401 with appropriate color. For another example, the system controller 201 determines the endoscope type based on the contents of the endoscope information, and superimpose the endoscope type information on the image displayed on the monitor 401. As shown in FIG. 1, the information contained in the EEPROM 106 is retrieved using the encoder 107.

According to the electronic endoscope system 1, the operator can control the processor 200 by operating the freeze button 141 and the copy button 142. The freeze button 141 is for controlling the processor 200 such that the image displayed on the monitor 401 is frozen. The copy button 142 is for controlling the processor 200 to print the image currently displayed on the monitor 401 with the video printer 402. Specifically, when the freeze button 141 is depressed, a freeze control signal is generated, and when the copy button 142 is depressed, a copy control signal is generated. The freeze control signal and the copy control signal are transmitted to the encoder 107.

The encoder 107 converts the freeze control signal and the copy control signal into digital data, and transmits the converted digital data to the multiplexer 108 together with the endoscope data retrieved from the EEPROM 106.

The multiplexer 108 detects the blanking interval of the multiplexed digital video signal based on the output of the synchronization word generating circuit 105. Then, the multiplexer 108 superimposes the endoscope information (i.e., the contents of the EEPROM 106) on the currently generated digital video signal at the blanking interval. The multiplexer 108 further superimposes the digitized freeze control signal and/or the copy control signal, if they exist, onto the currently generated digital video signal at the blanking interval. The structure of the digital video signal on which the endoscope information and digitized control signals have been superimposed will be described in detail later.

The multiplexed digital video signal is transmitted to the P/S (parallel-to-serial) converter 109, by which digital video signal data is encoded into a serial data stream (which will be referred to as a serial digital video signal, hereinafter). The serial digital video signal is transmitted to the S/P (serial-to-parallel) converter 203 through a serial cable 300. The S/P converter 203 decodes the serial data stream into a multiplexed digital video signal, which is in this example a ten-bit parallel digital signal. The decoded multiplexed digital video signal is transmitted to the video decoder circuit 205.

The timing circuit 204 extracts the synchronization words from the multiplexed digital video signal transmitted to the video decoder circuit 205, and transmits the extracted synchronization words to the video decoder circuit 205.

The video decoder circuit 205 then extracts effective lines 1-n from the multiplexed digital video signal, using the extracted synchronization words and transmitted from the timing circuit 204. Then, the video decoder circuit 205 transmits the extracted effective lines 1-n to the signal processing circuit 206.

Further, the video decoder circuit 205 extracts, using the synchronization words extracted by the timing circuit 204, the contents of the EEPROM 106, the digitized freeze control signal and the digitized copy control signal from the preceding vertical blanking interval of the digital video signal. The extracted data is transmitted to the system controller 201.

The signal processing circuit 206 converts the effective lines 1-n extracted by the video decoder circuit 205 into an analog video signal. The system controller 201 controls the signal processing circuit 206 to perform various procedures in accordance with the endoscope type information contained in the contents of the EEPROM 106. The thus generated analog video signal is transmitted to the video output terminal 207a. Then, the image captured by the CCD unit 110 is displayed on the monitor 401.

When the freeze control signal has been transmitted to the system controller 201, the system controller 201 controls the signal processing circuit 206 so that the analog video signal included in the frame that includes the freeze control signal is applied to the video output terminal 207a repeatedly. In this case, a still image of the observation image is displayed on the monitor 401.

When the copy control signal has been transmitted to the system controller 201, the system controller 201 transmits a printer control signal instructing the video printer 402 to print an image to the printer control signal output terminal 207b. The video printer 402 prints out a frame of image when the printer control signal is output from the printer control signal output terminal 207b.

According to the embodiment, the serial digital video signal is generated by the P/S converter 109, and the generated serial digital video signal is transmitted from the electronic endoscope 100 to the processor 200 through the serial cable 300. It should be noted that the embodiment can be modified such that the multiplexed digital video signals are directly transmitted to the video decoder circuit 205.

Alternatively, the serial digital video signal may be transmitted from the endoscope 100 to the processor 200 with a wireless data transmission method in accordance with, for example, an IEEE 802.11 standard.

Further alternatively, the serial digital video signal may be transmitted to the processor 200 using an infrared data transmission method in accordance with, for example, the IrDA standard.

Alternatively, the embodiment may be modified such that the serial digital video signal may be compressed, and the compressed data is transmitted to the processor 200 in accordance with the IEEE 1394 data transmission method.

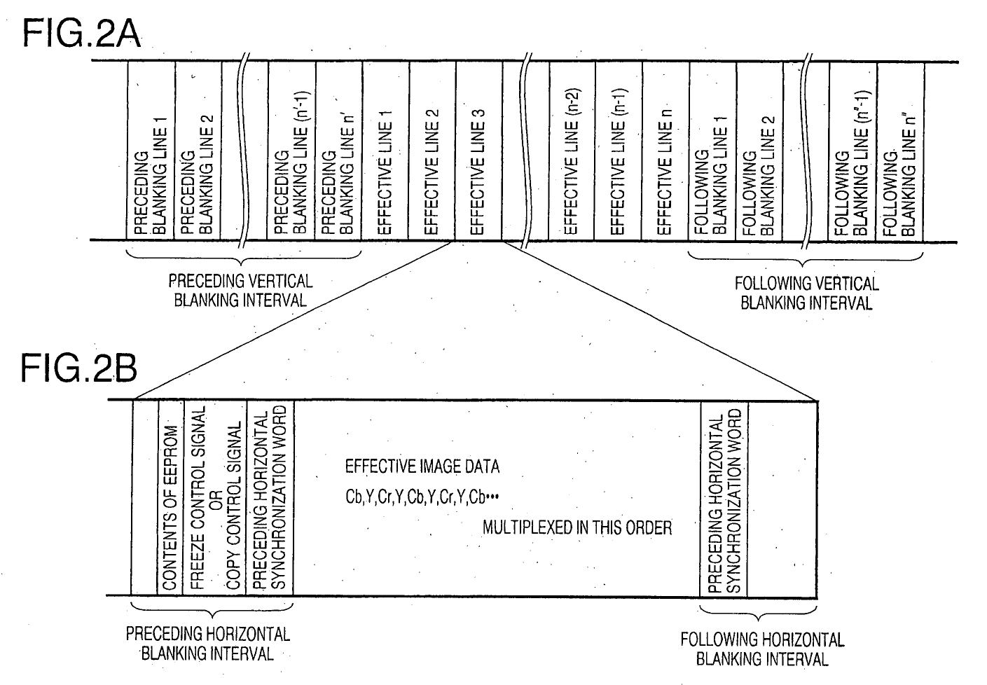

The structure of the multiplexed digital video signal will be described hereinafter with reference to FIGS. 2A and 2B.

The multiplexed digital video signal include, for one screen period, the preceding vertical blanking interval, effective line 1, effective line 2, . . . , effective line n, and following vertical blanking interval.

The preceding vertical blanking interval includes preceding blanking line 1, preceding blanking line 2, . . . , and preceding blanking line n′.

The following vertical blanking interval includes following blanking line 1, following blanking line 2, . . . , and following blanking line n″.

The monitor 401, which is capable of displaying images in accordance with the digital video signal, determines that n′-th word, counting from the preceding blanking line 1, is the effective line 1 when the preceding blanking line 1. Then, the monitor 401 displays the contents of the effective lines 1-n line by line. The following blanking lines 1-n″ are for indicating the end of one screen.

As shown in FIG. 2B, each of the effective lines 1-n includes a preceding horizontal blanking interval, effective image data and a following horizontal blanking interval. In a region within the preceding horizontal blanking interval and immediately before the effective image data, a preceding horizontal synchronization word is provided. In a region within the following horizontal blanking interval and immediately after the effective image data, a following horizontal synchronization word is provided. The preceding horizontal synchronization word and the following horizontal synchronization word are provided for indicating the top and end of the effective image data. In the region of the effective image data, digitized image signals are stored on a word basis in the order of Cb, Y. Cr, Y, Cb, Y . . . .

As aforementioned, and is indicated in FIG. 2B, according to the embodiment, the contents of the EEPROM 106, the digitized freeze control signal and the digitized copy control signal are superimposed on the digital video signal in a region included in the preceding horizontal blanking interval. The structure of the multiplexed digital video signal need not be limited to one indicated in FIG. 2B, and can be modified in various ways. That is, the contents of the EEPROM 106, the digitized freeze control signal and copy control signal may be superimposed on a region included in the following vertical blanking interval, the preceding vertical blanking period or the following horizontal blanking period.

The present disclosure relates to the subject matter contained in Japanese Patent Application No. 2003-101705, filed on Apr. 4, 2003, which is expressly incorporated herein by reference in its entirety.

What is claimed is:

1. An electronic endoscope system having an electronic endoscope and a processor that processes an output of the electronic endoscope,
the electronic endoscope including:
an image capturing element adapted to capture an image of an object to be observed;
a signal processing circuit that receives the output of the image capturing element and generates a digital video signal;
a digitized information outputting system that outputs digitized information representing at least information intrinsic to the electronic endoscope and control information for the processor; and
a digitized information superimposing system that superimposes the digitized information output by the digitized information outputting system on the digital video signal output by the signal processing circuit.

2. The electronic endoscope system according to claim 1, wherein the electronic endoscope is provided with a storage, which stores the information intrinsic to the electronic endoscope, the digitized information outputting system retrieving the information intrinsic to the electronic endoscope from the storage.

3. The electronic endoscope system according to claim 1, wherein the information intrinsic to the electronic endoscope includes a type of the electronic endoscope.

4. The electronic endoscope system according to claim 3,
wherein the electronic endoscope outputs the digital video signal including the superimposed digitized information to the processor, and
wherein the processor processes the digital video signal extracted from the output of the electronic endoscope in accordance with the information intrinsic to the electronic endoscope.

5. The electronic endoscope system according to claim 1,
wherein the electronic endoscope is provided with at least one operable member which can be operated by a user, and
wherein the digitized information outputting system outputs the control information in response to an operation of the at least one operable member.

6. The electronic endoscope system according to claim 5, wherein the processor includes an extracting system that extracts the digitized information from the digital video signal including the superimposed digitized information.

7. The electronic endoscope system according to claim 6, wherein the processor includes a controller that controls a device to which the digitized information as extracted is directed.

8. The electronic endoscope system according to claim 7, wherein the processor is connected with a displaying device, the controller controlling the displaying device in accordance with the control information represented by the digitized information.

9. The electronic endoscope system according to claim 7, wherein the processor is connected with a printing device, the controller controlling the printing device in accordance with the control information represented by the digitized information.

10. The electronic endoscope system according to claim 1, wherein the digital video signal output by the signal processing system includes luminance signal and color difference signals which are multiplexed in accordance with a time-division multiplexing method.

11. The electronic endoscope system according to claim 10, wherein the digitized information superimposing system superimposes the digitized information such that the luminance signal, color difference signals and the digitized information are multiplexed in accordance with a time-division multiplexing method.

12. The electronic endoscope system according to claim 11,
wherein the multiplexed luminance signal, color difference signals and the digitized information is a parallel digital video signal, and
wherein the electronic endoscope further includes a converting system that converts the parallel digital video signal into a serial digital video signal.

13. A method of controlling a processor of an electronic endoscope system that includes an electronic endoscope and the processor, comprising:
the electronic endoscope generating a digital video signal;
the electronic endoscope superimposing control information to control the processor on the digital video signal;
the electronic endoscope transmitting the superimposed digital video signal including the control information superimposed;
the processor receiving the superimposed digital video signal and extracting the control information; and
the processor operating in accordance with the control information.
